(19) United States
(12) Patent Application Publication
(10) Pub. No.: US 2013/0208445 A1
(43) Pub. Date: Aug. 15, 2013

(54) Modified bodipy dye matrix

(71) Applicants: Zhang-Lin Zhou, Palo Alto, CA (US); Gary Gibson, Palo Alto, CA (US); Lihua Zhao, Sunnyvale, CA (US)

(72) Inventors: Zhang-Lin Zhou, Palo Alto, CA (US); Gary Gibson, Palo Alto, CA (US); Lihua Zhao, Sunnyvale, CA (US)

(21) Appl. No.: 13/878,177

(22) PCT Filed: Oct. 6, 2010
(86) PCT No.: PCT/US10/51582

§ 371 Date: Apr. 5, 2013

(51) Int. Cl. C09K 11/06; F21V 9/16

(52) U.S. Cl. CPC C09K 11/06; F21V 9/16
USPC 362/84; 252/301.35

(57) ABSTRACT

The present disclosure is directed towards a modified BODIPY dye matrix, luminescence-based pixels, luminescence-based sub-pixels, and methods using a modified BODIPY dyes. The modified BODIPY dye matrix includes a modified BODIPY dye and a polymer matrix including a radiation absorber.

### BACKGROUND

A reflective display is a non-emissive device in which ambient light is used for viewing the displayed information. Rather than modulating light from an internal source, desired portions of the incident ambient light spectrum are reflected from the display back to a viewer. Electronic paper (e-paper) technologies have evolved to provide single layer monochromatic displays that control the reflection of ambient light. Luminescence-based materials provide alternative, more efficient pathways for utilizing ambient light in reflective displays, thereby making bright, full color reflective displays possible.

### BRIEF DESCRIPTION OF THE DRAWINGS

FIG. 1 is a cross-sectional view of a luminescence-based sub-pixel in accordance with an example of the present disclosure;

FIG. 2 is a cross-sectional view of a luminescence-based pixel in accordance with an example of the present disclosure;

FIG. 3 is a cross-sectional view of another luminescence-based pixel in accordance with an example of the present disclosure; and

FIG. 4 is a flow chart setting forth a method in accordance with an example of the present disclosure.

### DETAILED DESCRIPTION

It is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “alkyl” refers to a branched, unbranched, or cyclic saturated hydrocarbon group, which typically, although not necessarily, includes from 1 to 50 carbon atoms, or 1 to 30 carbon atoms, or 1 to 6 carbons, for example. Alkyls include, but are not limited to, methyl, ethyl, n-propyl, isopropyl, n-butyl, isobutyl, t-butyl, octyl, and decyl, for example, as well as cycloalkyl groups such as cyclopentyl, and cyclohexyl, for example.

As used herein, “aryl” refers to a group including a single aromatic ring or multiple aromatic rings that are fused together, directly linked, or indirectly linked (such that the different aromatic rings are bound to a common group such as a methylene or ethylene moiety). Aryl groups described herein may include, but are not limited to, from 5 to about 50 carbon atoms, or 5 to about 40 carbon atoms, or 5 to 30 carbon atoms or more. Aryl groups include, for example, phenyl, naphthyl, anthryl, phenanthryl, biphenyl, diphenylether, diphenylamine, and benzophenone. The term “substituted aryl” refers to an aryl group comprising one or more substituent groups. The term “heteroaryl” refers to an aryl group in which at least one carbon atom is replaced with a heteroatom. If not otherwise indicated, the term “aryl” includes unsubstituted aryl, substituted aryl, and heteroaryl.

As used herein, “substituted” means that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, and thioaryl.

The terms “halo” and “halogen” refer to a fluoro, chloro, bromo, or iodo substituent.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

It has been recognized that it would be advantageous to develop modified 4,4-difluoro-4-bora-3a,4a-diaza-s-indacene (BODIPY) dyes suitable for a wide variety of applications. In accordance with this, compositions, devices, and methods described herein can include modified BODIPY dyes dispersed in a polymer matrix that can emit various wavelengths of light. As such, modified BODIPY dye matrices can be used in luminescence-based sub-pixels and luminescence-based pixels. It is noted that when discussing the present compositions, devices and methods, each of these discussions can be considered applicable to each of these examples, whether or not they are explicitly discussed in the context of that example. Thus, for example, in discussing a modified BODIPY dye used in a luminescence-based sub-pixel, such a modified BODIPY dye can also be used in a luminescence-based pixel or a method for illuminating a display, and vice versa.

A modified BODIPY dye matrix can comprise a modified BODIPY dye having the structure:

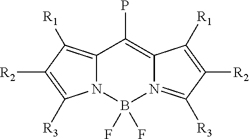

where R₁, R₂, and R₃ are independently selected from the group of C₁-C₃₀ alkyl, C₁-C₃₀ alkenyl, C₁-C₃₀ alkynyl, C₁-C₃₀ aryl, C₁-C₃₀ alkoxy, C₁-C₃₀ pheoxy, C₁-C₃₀ thioalkyl, C₁-C₃₀ thioaryl, C₁-C₃₀ C(O)OR₄, N(R₅)(R₆), C(O)N(R₅)(R₆), F, Cl, Br, NO₂, CN, acyl, carboxylate, and hydroxyl, wherein R₄, R₅ and R₆ are independently selected from the group of hydrogen, C₁-C₃₀ alkyl, and C₁-C₃₀ aryl and wherein P is a polymer or oligomer selected from the group of:

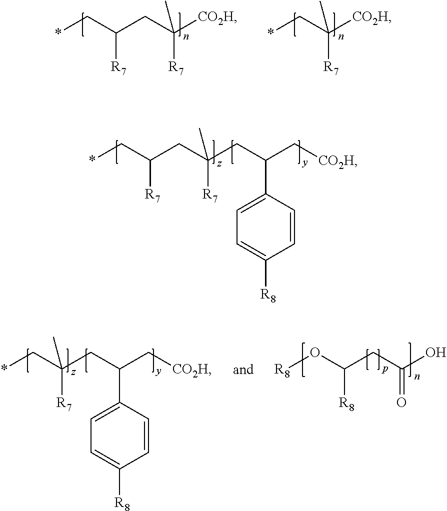

where R₇ is CO₂R₈, and R₈ is selected from the group of methyl, ethyl, butyl, t-butyl, and hexyl; n is from 2 to 500; z is from 2 to 500; y is from 2 to 500; and p is from 1 to 30. The composition can include a polymer matrix comprising a radiation absorber. The polymer of the polymer matrix can be a host polymer(s) such as inert polymer(s), cross-linked polymer(s), etc. The radiation absorber absorbs electromagnetic radiation. In one example, the electromagnetic radiation can be ultraviolet (UV), infrared (IR), and/or visible electromagnetic radiation. Further, the modified BODIPY dye can be dispersed in the polymer matrix.

Additionally, a luminescence-based sub-pixel can comprise a light shutter with adjustable transmission and a luminescent layer disposed below the light shutter, the luminescent layer including a modified BODIPY dye in a polymer matrix. The sub-pixel can also comprise a mirror disposed below the luminescent layer for reflecting light emitted from the modified BODIPY dye, where the modified BODIPY dye can be a modified BODIPY dye as described herein. The mirror can also be used to reflect light that is not absorbed by the modified BODIPY dye, including those wavelengths that are not intended to be absorbed by the BODIPY dye as well as reflecting wavelengths that are intended to be absorbed back through the luminescent layer.

Further, a luminescence-based pixel can comprise three luminescent-based sub-pixels, including any of those described herein, wherein each luminescence-based sub-pixel corresponds to a different color of emitted light such that the luminescence-based pixel can emit light over a spectrum of 300 to 800 nm.

Various modifications and combinations that can be derived from the present disclosure and illustrations, and as such, the following figures should not be considered limiting.

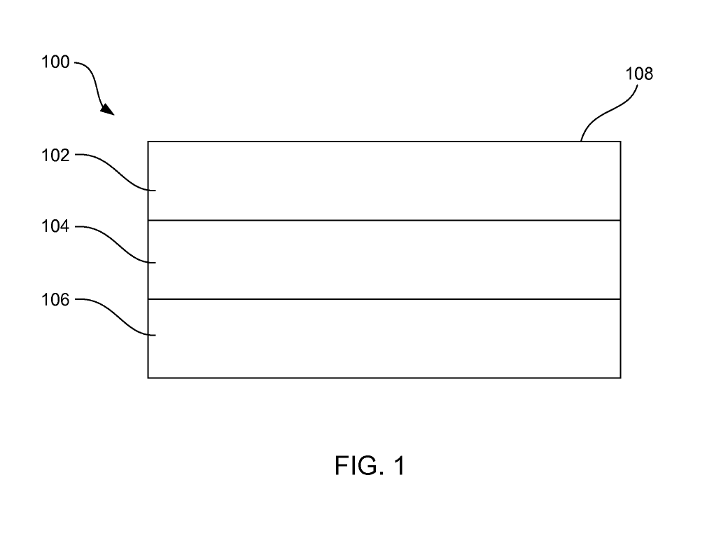

Turning now to FIG. 1, a luminescence-based sub-pixel 100 can comprise a shutter 102, a luminescent layer 104, and a mirror 106. The shutter can form the top layer of the sub-pixel, and ambient light for illumination can enter the sub-pixel through the shutter. The shutter can have a light transmission that is adjustable. The shutter can modulate the intensity of ambient light entering the sub-pixel and also the light leaving the sub-pixel. In this way, the shutter can control the amount of light produced by the sub-pixel to achieve the desired brightness. In some examples, the shutter can comprise an electro-optic shutter, the transparency of which can be modulated from mostly transparent to mostly opaque, over some range of wavelengths and with some number of intermediate gray levels. There are a number of possible choices for the electro-optic shutter, including black/clear dichroic-liquid crystal (LC) guest-host systems and in-plane electrophoretic (EP) systems. If a dichroic LC system is used, in some examples, a quarter-wave plate may be disposed between the liquid crystal shutter and the luminescent material. Other options include cholesteric liquid crystal cells, in-plane electrophoretic devices, or electrowetting layers.

The luminescent layer 104 can include a modified BODIPY dye having the structure:

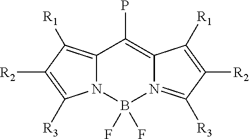

where R₁, R₂, and R₃ are independently selected from the group of C₁-C₃₀ alkyl, C₁-C₃₀ alkenyl, C₁-C₃₀ alkynyl, C₁-C₃₀ aryl, C₁-C₃₀ alkoxy, C₁-C₃₀ pheoxy, C₁-C₃₀ thioalkyl, C₁-C₃₀ thioaryl, C₁-C₃₀ C(O)OR₄, N(R₅)(R₆), C(O)N(R₅)(R₆), F, Cl, Br, NO₂, CN, acyl, carboxylate, and hydroxyl, wherein R₄, R₅ and R₆ are independently selected from the group of hydrogen, C₁-C₃₀ alkyl, and C₁-C₃₀ aryl and wherein P is a polymer or oligomer selected from the group of

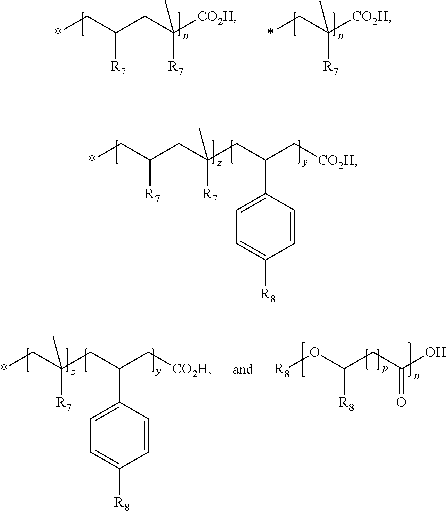

where R₇ is CO₂R₈, and R₈ is selected from the group of methyl, ethyl, butyl, t-butyl, and hexyl; n is from 2 to 500; z is from 2 to 500; y is from 2 to 500; and p is from 1 to 30. In one example, P can be

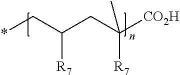

where R₇ is independently CO₂CH₃, CO₂C₂H₅, CO₂C₃H₇, CO₂C₄H₉, or CO₂C₄H₉-tert; and n is from 2 to 100. In another example, P can be

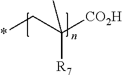

where R₇ is CO₂CH₃, CO₂C₂H₅, CO₂C₃H₇, CO₂C₄H₉, or CO₂C₄H₉-tert; and n is from 2 to 100. In still another example, P can be

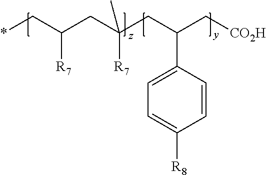

where R₇ is independently CO₂CH₃, CO₂C₂H₅, CO₂C₃H₇, CO₂C₄H₉, or CO₂C₄H₉-tert; R₈ is CH₃, C₂H₅, C₃H₇, C₄H₉, tert-C₄H₉, or F; z is from 2 to 100, and y is from 2 to 100. In yet another example, P can be

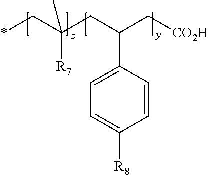

where R₇ is CO₂CH₃, CO₂C₂H₅, CO₂C₃H₇, CO₂C₄H₉, or CO₂C₄H₉-tert; R₈ is CH₃, C₂H₅, C₃H₇, C₄H₉, tert-C₄H₉, or F; z is from 2 to 100; and y is from 2 to 100. In still yet another example, P can be

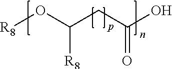

where R₈ is independently CH₃, C₂H₅, C₃H₇, C₄H₉, or tert-C₄H₉; p is 10, 12, 14, 16, or 18, and n is from 2 to 100. In one example, P can include poly(methacrylate) copolymers, poly(methyl methacrylate) copolymers, and polystyrene copolymers. The polymers/oligomers described above can include various polymer architectures including random copolymers, block copolymers, and alternating copolymers.

Additionally, the modified BODIPY dye can be functionalized with acidic or basic groups. In one example, R₁, R₂, and/or R₃ can be a carboxylic acid group or an amine group. In one aspect, the modified BODIPY dye can be functionalized with a carboxylic acid group. In another aspect, the modified BODIPY dye can be functionalized with an amine group. The modified BODIPY dye can be present in the luminescent layer from about 0.01% to about 10% by weight. In one example, the modified BODIPY dye can be present in the luminescent layer from about 0.05% to about 2% by weight.

Additionally, the luminescent layer can include a polymer matrix. The polymer matrix can be a transparent host polymer(s) and/or can include polymer and other non-polymer compounds, such as the modified BODIPY dye(s), radiation absorber(s), etc. The radiation absorbers can absorb energy in the form or electromagnetic radiation and transfer the energy to the modified BODIPY dye via a resonant energy transfer mechanism; e.g., via Förster exchange. The radiation absorbers can include emissive polymer, dyes, or other radiation absorbing materials. In one example, the radiation absorbers can be an emissive polymer including, without limitation, poly(9,9′-dioctylfluorene-co-benzothiadiazole); poly[2-methoxy-5-(2′-ethyl-hexyloxy)-1,4-phenylene vinylene]; polyfluorenes; substituted polyfluorenes; polycarbazoles; substituted polycarbazoles; co-polymers of fluorene and carbazole; co-polymers of fluorene and benzothiadiazole; copolymers of fluorene and phenothiazine; and mixtures thereof. In another example, the radiation absorber can include organic dyes, inorganic phosphors, and/or semiconducting nanocrystals. In one aspect, the radiation absorber can include without limitation BODIPY dyes, perylenes, pyromethenes, rhodamines, sulforhodamines, coumarins, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures and derivatives thereof. Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange CAS 2243-76-7, Methyl Yellow (60-11-7), 4-phenylazoaniline (CAS 60-09-3), Alcian Yellow (CAS 61968-76-1), available from Aldrich chemical company, and mixtures thereof. In one aspect, the radiation absorber can include without limitation quinoline dyes, porphyrins, porphins, and mixtures and derivatives thereof. Further, the luminescent layer can include anti-oxidants or other radiation absorbers, e.g., UV absorbers, used to protect the luminescent dyes from photo-oxidation, thereby making them more robust and photofast. Examples of anti-oxidants can include sterically hindered amines, substituted phenols, and nitro substituted aromatic compounds such as N-methylmorphine, N-methyl morphine oxide, nitrobenzene, 9-nitroanthracene, 2,2′-dinitrobiphenyl, 2,2,6,6-tetramethylpiperidine, N-phenyl-1-napthylane, 2,4,6-tertbutylphenol, etc.

Additionally, the polymer matrix can include a mixture of various radiation absorbers. The radiation absorbers can be present in the luminescent layer from about 0.01% to about 99.99% by weight. In one example, the radiation absorbers can be present in the luminescent layer from about 0.05% to about 2% by weight.

The modified BODIPY dye can be tuned to match an emissive energy level of the radiation absorber. The tuning can be performed by generally matching the modified BODIPY dye's absorption wavelengths to the radiation absorber's emission wavelength. The matching can provide an overlap between these wavelength ranges allowing for energy transfer between the radiation absorber and the modified BODIPY dye via a resonant energy transfer mechanism as discussed herein such as Förster exchange mechanism. In one example, the radiation absorber can absorb electromagnetic radiation having a wavelength of 300 nm to 800 nm. Tuning can also be accomplished by attaching certain moieties to the modified BODIPY dyes that can alter the absorption or emission spectra of the dyes.

The luminescent layer can absorb some, but not necessarily all, light with wavelengths shorter than an absorption edge, λ_{abs}, with a substantial fraction of the absorbed energy re-radiated by the modified BODIPY dyes in a band around an emission wavelength λₑₘᵢₛ that is longer than the absorption edge. This can provide a large advantage in efficiency over devices that merely reflect a portion of the spectrum of the incident light. A large fraction of the incident energy at wavelengths below the absorption wavelength (including UV) can be utilized rather than just the small portion that falls within the particular color band. For example, in the case of a red sub-pixel, this can provide a several-fold improvement in brightness for a given sub-pixel area. In general, it is desirable to use a luminescent layer whose absorption extends from some cutoff, λ_{abs}, down to the shortest wavelengths available in typical ambient environments. In practice, there might be negligible benefit in absorbing much below 320 nm, although somewhat shorter wavelengths may contribute in outdoor environments if the top layers of the pixels and sub-pixels are reasonably transparent in this region.

The polymer matrix can include other polymers in which the modified BODIPY dye can be dispersed, including the transparent polymers as discussed above. Such polymers do not provide energy transfer but can be added to the polymer matrix in addition to the energy transfer materials. For example, a polymer matrix can include a transparent polymer, a radiation absorber, and a modified BODIPY dye. The transparent polymer can include, without limitation, alkly polyacrylate, alkyl polymethacrylate, cross-linked alkly polyacrylate, poly(methyl methacrylate), polycarbonate, polystyrene, polyethylene terephthalate, polyethylene naphthalate, polyvinyl alcohol, and mixtures thereof. Generally, the modification of the modified BODIPY dye can provide increased miscibility and/or solubility of the dye in the polymer matrix. In one example, the modified BODIPY dye can be miscible and/or soluble with any solvent present in the polymer matrix or used before film formation of the luminescent layer. In another example, the modified BODIPY dyes can be miscible and/or soluble with any polymers included in the polymer matrix or that comprise the matrix. Such solubility and/or miscibility can provide a uniform distribution of the dye within the polymer matrix. The modification of the BODIPY dye can also provide tailored absorption or emission spectra. Such compatibility of the modified BODIPY dyes and the polymer matrix can improve emission efficiency of the modified BODIPY dye matrices described herein, including the present luminescent layers, by preventing or minimizing luminescence quenching of the dyes from dye agglomeration. Additionally, the improved solubility can provide for higher concentrations of BODIPY dyes in the luminescent layers without luminescence quenching, thereby allowing an overall layer thickness of less than 10 μm while still obtaining adequate absorption from the BODIPY dyes within the layer. In one example, the overall thickness can be less than 5 μm.

The polymer matrix can also include solvents, e.g., those used prior to film formation. In one example, the solvent can be an organic solvent. Solvents than can be used include, without limitation, chloroform, chlorobenzene, toluene, alcohols, and other organic solvents such as benzene, xylenes, iso-propanol, iso-hexafluoropropanol, ethyl acetate, cyclohexanes, dodecanes, isopars, dimethylformamide, dimethyl sulfoxide, N-methylpyrrolidone etc.

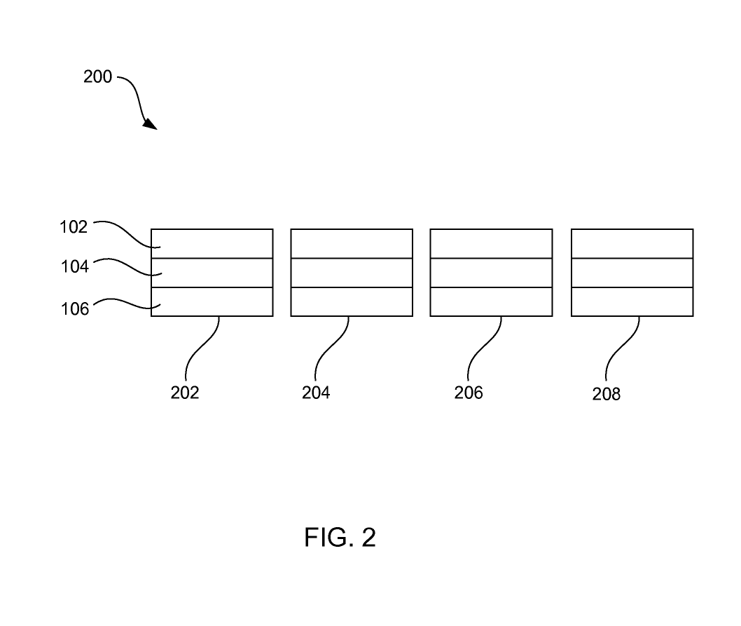

Below the luminescent layer, the sub-pixel can include a mirror 136 that reflects a selected portion of the optical spectrum. This mirror can be, for example, a Bragg stack, an absorbing dye over a broadband mirror, or a layer of optical scatterers such as plasmonic particles. The latter two options may be beneficial in terms of the ease with which mirrors with different reflection bands can be manufactured in a side-by-side sub-pixel configuration (as shown in FIG. 2). They also may be chosen for their reduced dependence on the angle of incidence of the ambient light.

The mirror can be wavelength-selective in that it reflects only light in a selected bandwidth. The reflection bandwidth may be chosen so that the mirror reflects light of the primary color of the sub-pixel but does not reflect other wavelengths. In other cases, the mirror may reflect wavelengths that are absorbed by the luminescent layer as well as wavelengths that contribute to the desired color of the sub-pixel. For example, the mirror for a green sub-pixel can reflect green and blue light but may not reflect any red portion of the incident light. Similarly, the mirror for a blue sub-pixel may reflect blue, and perhaps near UV wavelengths, but not red or green wavelengths. The mirror can enhance the performance of the color sub-pixel in three regards. First, it can re-direct light that is emitted by the modified BODIPY dyes away from the viewing surface 108. By reflecting the emitted light back toward the viewing surface, the total amount of light from the sub-pixel available for viewing can be significantly increased. In this regard, with a reasonable Stokes shift (λₑₘᵢₛ-λ_{abs}) separating the absorption edge and the emission wavelength of the luminescent layer, the modified BODIPY dye will not significantly re-absorb the reflected emitted light as it passes back through the luminescent layer and out of the viewing surface.

Second, the wavelength-selective mirror can enable one to take optimum advantage of the portion of incident ambient light not significantly absorbed by the luminescent layer but with wavelengths that contribute to the creation of the desired color. This portion, which, in general, includes light with wavelengths between λ_{abs} and λₑₘᵢₛ (i.e., within the Stoke shift range) and somewhat beyond λₑₘᵢₛ, will reach the mirror. Some of this light may then be reflected back toward the viewing surface so that it contributes to the overall output of the sub-pixel. Without the mirror, this light is wasted. In some examples, the reflection band of the mirror can be chosen such that it starts at a cut-off wavelength longer than the emission wavelength, and extends to shorter wavelengths that include the absorption edge wavelength λ_{abs} of the luminescent layer. The long-wavelength cut-off of the mirror reflection can be set at the long-wavelength edge of the color band assigned to that sub-pixel. For example, for a red sub-pixel, the reflection band may reach or even go beyond the long-wavelength edge of the standard range of red, as it may be desirable to reflect red out to the limits of human perception. In some examples, a diffusive mirror may be used to randomize the direction of propagation of the emitted light each time it is reflected by the mirror. Diffusive mirrors can be made that scatter the reflected light within a desired characteristic angular range.

The luminescent layers can be configured to emit a specific color of light. The color can be any color including without limitation red, blue, green, cyan, yellow, magenta, etc. In one example, the modified BODIPY dye can emit light at a wavelength from 600 to 800 nm corresponding to a red color. In another example, the modified BODIPY dye can emit light at a wavelength from 500 to 600 corresponding to a green color. In yet another example, the modified BODIPY dye can emit light at a wavelength from 400 to 500 corresponding to a blue color.

The luminescent layers can have high emission efficiency. In one example, the internal emission efficiency can be greater than 80% when the modified BODIPY dye is present in the polymer matrix at a concentration of about 0.1% to about 1% by weight.

While the present discussion has been generally referenced in the context of FIG. 1, it is noted that the above examples are equally applicable to the modified BODIPY dye matrix, luminescence-based pixels, and associated methods discussed herein as well.

Turning now to FIG. 2, a luminescence-based pixel 200 can comprise 3 colored sub-pixels, 202, 204, and 206 in a side-by-side architecture. Each sub-pixel can correspond to a specific color of light. For example, sub-pixel 202 can be a red sub-pixel, sub-pixel 204 can be a green sub-pixel, and sub-pixel 206 can be a blue sub-pixel. Additionally, the luminescence-based pixel can include additional sub-pixels. For example, the luminescence-based pixel can include sub-pixel 208, corresponding to a white color. It is understood that the number of sub-pixels can vary according to the needs of the respective application. In one example, the luminescence-based pixel can be part of a reflective display. Additionally, the luminescence-based pixel comprising three luminescence-based sub-pixels, where each luminescence-based sub-pixel corresponds to a different color of emitted light, can emit light over a spectrum of 300 nm to 800 nm.

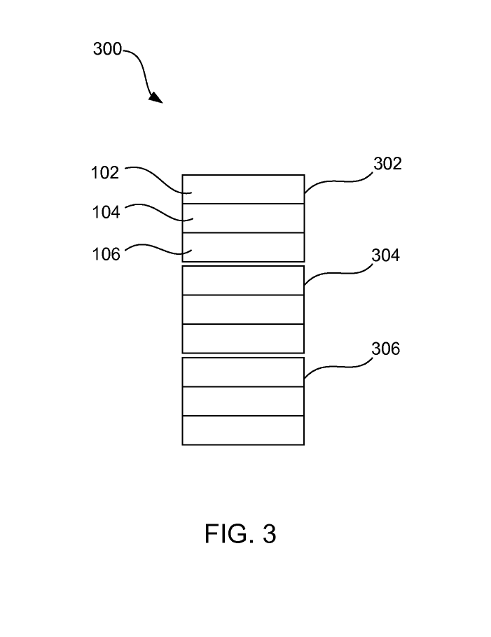

Turning now to FIG. 3, a luminescence-based pixel 300 can comprise 3 colored sub-pixels, 302, 304, and 306 in a stacked architecture. Each sub-pixel can correspond to a specific color of light. For example, sub-pixel 302 can be a red sub-pixel, sub-pixel 304 can be a green sub-pixel, and sub-pixel 306 can be a blue sub-pixel. Additionally, the luminescence-based pixel can include additional sub-pixels. It is understood that the number of sub-pixels can vary according to the needs of the respective application. In one example, the luminescence-based pixel can be part of a reflective display. Additionally, the luminescence-based pixel comprising three luminescence-based sub-pixels, where each luminescence-based sub-pixel corresponds to a different color of emitted light, can emit light over a spectrum of 300 nm to 800 nm. The stacked architecture can include electrodes, electrode layers, liquid crystal alignment layers, guest-host layers including dichroic dye (the guest) dissolved in a liquid crystal (LC) host, etc (not shown).

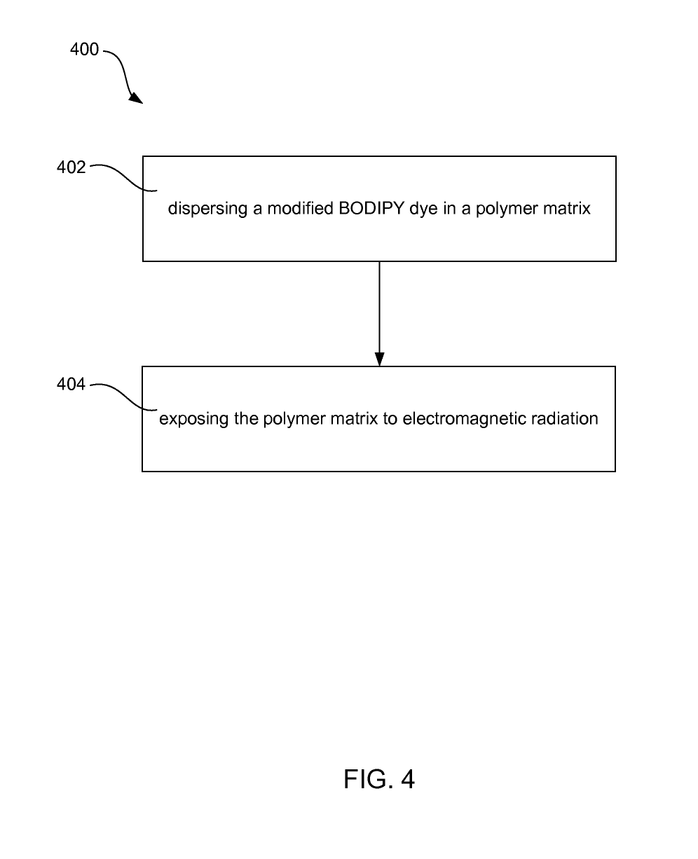

Turning now to FIG. 4, a method 400 for illuminating a display can comprise dispersing a modified BODIPY dye in a polymer matrix 402 and exposing the polymer matrix to electromagnetic radiation 404. As previously discussed, the modified BODIPY dye can be any such dyes described herein. Additionally, in one example, the method can further comprise tuning the modified BODIPY dye to match an emission energy level of a radiation absorber dispersed within the polymer matrix, as previously discussed. Further, in another example, the method can comprise providing a shutter and a mirror as described herein.

### EXAMPLES

The following examples illustrate some examples of the present modified BODIPY dye matrices, luminescence-based pixels, luminescence-based sub-pixels, and methods that are presently known. However, it is to be understood that the following are only exemplary or illustrative of the application of the principles of the present compositions, devices, and methods. Numerous modifications and alternative compositions, methods, and devices may be devised by those skilled in the art without departing from the spirit and scope of the present compositions and methods. The appended claims are intended to cover such modifications and arrangements.

### Example 1

### Synthesis of Modified BODIPY Dyes

A modified BODIPY dye is prepared by reacting a substituted pyrrole 1 with polymeric acid chloride in dichloromethane and then petroleum ether giving an intermediate hydrochloride salt 2 according to the following reaction scheme:

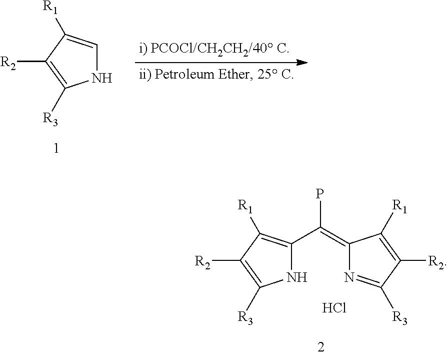

Neutralization of intermediate 2 with triethylamine or diisopropylethylamine, followed by treatment with trifluoroboron ether complex provides the desired modified BODIPY dye 3 according to the following reaction scheme:

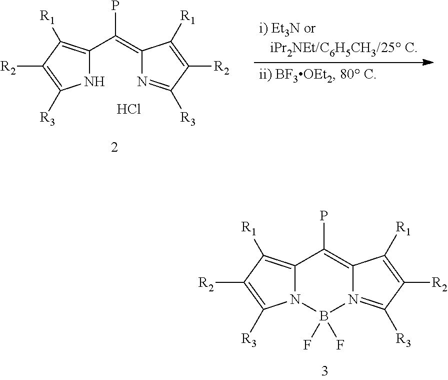

### Example 2

### Synthesis of Modified BODIPY Dye Matrix

A modified BODIPY dye matrix is prepared by admixing the modified BODIPY dye of Example 1 in an emissive polymer providing approximately 1% of modified BODIPY in the polymer by weight in poly(methyl acrylate) and sonicating the mixture for one hour. The polymer can be provided in a solvent, such as toluene or other suitable solvent.

While the disclosure has been described with reference to certain examples, those skilled in the art will appreciate that various modifications, changes, omissions, and substitutions can be made without departing from the spirit of the disclosure.

What is claimed is:

1. A modified BODIPY dye matrix, comprising:
a modified BODIPY dye having the structure: 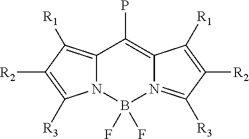
where R₁, R₂, and R₃ are independently selected from the group of C₁-C₃₀ alkyl, C₁-C₃₀ alkenyl, C₁-C₃₀ alkynyl, C₁-C₃₀ aryl, C₁-C₃₀ alkoxy, C₁-C₃₀ pheoxy, C₁-C₃₀ thioalkyl, C₁-C₃₀ thioaryl, C₁-C₃₀ C(O)OR₄, N(R₅)(R₆), C(O)N(R₅)(R₆), F, Cl, Br, NO₂, CN, acyl, carboxylate, and hydroxyl, wherein R₄, R₅ and R₆ are independently selected from the group of hydrogen, C₁-C₃₀ alkyl, and C₁-C₃₀ aryl and wherein P is a polymer or oligomer selected from the group of: 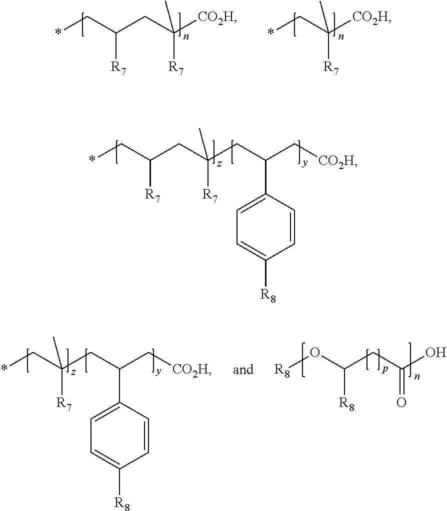
where R₇ is CO₂R₈, and R₈ is selected from the group of methyl, ethyl, butyl, t-butyl, and hexyl; n is from 2 to 500; z is from 2 to 500; y is from 2 to 500; and p is from 1 to 30; and
a polymer matrix including a radiation absorber;
wherein the modified BODIPY dye is dispersed in the polymer matrix.

2. The modified BODIPY dye matrix of claim 1, wherein the radiation absorber includes an emissive polymer selected from the group of poly(9,9′-dioctylfluorene-co-benzothiadiazole), poly[2-methoxy-5-(2′-ethyl-hexyloxy)-1,4-phenylene vinylene], polyfluorenes, substituted polyfluorenes, polycarbazoles, substituted polycarbazoles, co-polymers of fluorene and carbazole, co-polymers of fluorene and benzothiadiazole, copolymers of fluorene and phenothiazine, and mixtures thereof.

3. The modified BODIPY dye matrix of claim 1, wherein the radiation absorber is selected from the group of BODIPY dyes, perylenes, pyromethenes, rhodamines, sulforhodamines, coumarins, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures and derivatives thereof.

4. The modified BODIPY dye matrix of claim 1, wherein the radiation absorber absorbs electromagnetic radiation having a wavelength of 300 nm to 800 nm.

5. The modified BODIPY dye matrix of claim 1, wherein the modified BODIPY dye is uniformly distributed in the polymer matrix.

6. The modified BODIPY dye matrix of claim 1, wherein the modified BODIPY dye is tuned to match an emission energy level of the radiation absorber.

7. The modified BODIPY dye matrix of claim 1, wherein the modified BODIPY dye emits light at a wavelength from 600 nm to 800 nm corresponding to a red color, emits light at a wavelength from 500 to 600 nm corresponding to a green color, or emits light at a wavelength from 400 nm to 500 nm corresponding to a blue color.

8. A luminescence-based sub-pixel, comprising:
a light shutter with adjustable transmission;
a luminescent layer disposed below the light shutter, the luminescent layer including a modified BODIPY dye in a polymer matrix; and
a mirror disposed below the luminescent layer for reflecting light emitted from the modified BODIPY dye;
wherein the modified BODIPY dye has the structure: 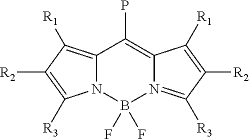
where R₁, R₂, and R₃ are independently selected from the group of C₁-C₃₀ alkyl, C₁-C₃₀ alkenyl, C₁-C₃₀ alkynyl, C₁-C₃₀ aryl, C₁-C₃₀ alkoxy, C₁-C₃₀ pheoxy, C₁-C₃₀ thioalkyl, C₁-C₃₀ thioaryl, C₁-C₃₀ C(O)OR₄, N(R₅)(R₆), C(O)N(R₅)(R₆), F, Cl, Br, NO₂, CN, acyl, carboxylate, and hydroxyl, wherein R₄, R₅ and R₆ are independently selected from the group of hydrogen, C₁-C₃₀ alkyl, and C₁-C₃₀ aryl and wherein P is a polymer or oligomer selected from the group of: 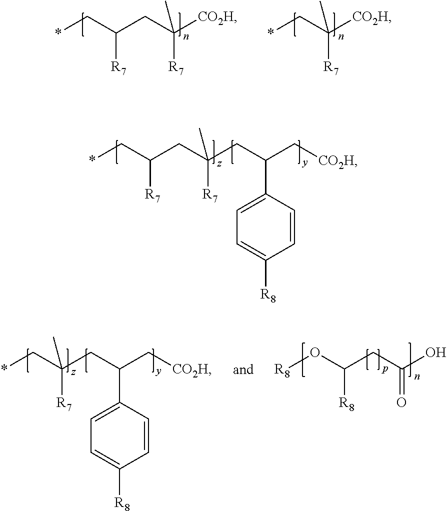
where R₇ is CO₂R₈, and R₈ is selected from the group of methyl, ethyl, butyl, t-butyl, and hexyl; n is from 2 to 500; z is from 2 to 500; y is from 2 to 500; and p is from 1 to 30.

9. The luminescence-based sub-pixel of claim 8, wherein the polymer matrix further includes a radiation absorber.

10. The luminescence-based sub-pixel of claim 9, wherein radiation absorber includes an emissive polymer selected from the group of poly(9,9′-dioctylfluorene-co-benzothiadiazole), poly[2-methoxy-5-(2′-ethyl-hexyloxy)-1,4-phenylene vinylene], polyfluorenes, substituted polyfluorenes, polycarbazoles, substituted polycarbazoles, co-polymers of fluorene and carbazole, co-polymers of fluorene and benzothiadiazole, copolymers of fluorene and phenothiazine, and mixtures thereof.

11. The luminescence-based sub-pixel of claim 9, wherein the radiation absorber is selected from the group of BODIPY dyes, perylenes, pyromethenes, rhodamines, sulforhodamines, coumarins, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures and derivatives thereof.

12. The luminescence-based sub-pixel of claim 8, wherein the luminescence-based sub-pixel is part of a reflective display.

13. A luminescence-based pixel comprising three luminescence-based sub-pixels of claim 8, wherein each luminescence-based sub-pixel corresponds to a different color of emitted light such that the luminescence-based pixel can emit light over a spectrum of 300 to 800 nm.

14. A method of illuminating a display, comprising:
dispersing a modified BODIPY dye in a polymer matrix, wherein the modified BODIPY dye has the structure: 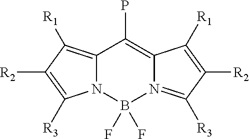
where R₁, R₂, and R₃ are independently selected from the group of C₁-C₃₀ alkyl, C₁-C₃₀ alkenyl, C₁-C₃₀ alkynyl, C₁-C₃₀ aryl, C₁-C₃₀ alkoxy, C₁-C₃₀ pheoxy, C₁-C₃₀ thioalkyl, C₁-C₃₀ thioaryl, C₁-C₃₀ C(O)OR₄, N(R₅)(R₆), C(O)N(R₅)(R₆), F, Cl, Br, NO₂, CN, acyl, carboxylate, and hydroxyl, wherein R₄, R₅ and R₆ are independently selected from the group of hydrogen, C₁-C₃₀ alkyl, and C₁-C₃₀ aryl and wherein P is a polymer or oligomer selected from the group of: 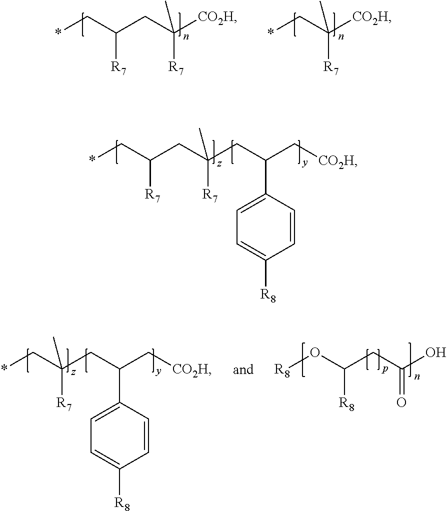
where R₇ is CO₂R₈, and R₈ is selected from the group of methyl, ethyl, butyl, t-butyl, and hexyl; n is from 2 to 500; z is from 2 to 500; y is from 2 to 500; and p is from 1 to 30; and
exposing the polymer matrix to electromagnetic radiation.

15. The method of claim 14, further comprising tuning the modified BODIPY dye to match an emission energy level of a radiation absorber in the polymer matrix.
